(19) United States
(12) Patent Application Publication
(10) Pub. No.: US 2002/0081098 A1
(43) Pub. Date: Jun. 27, 2002

(54) Compressed-data processing arrangement and related method

(75) Inventor: Brian M. Scally, Damascus, MD (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/023,252

(22) Filed: Dec. 18, 2001

(30) Foreign Application Priority Data
Dec. 21, 2000 (GB) 0031221.5

(51) Int. Cl. H04N 5/92; H04N 7/04; H04N 7/06; H04N 7/08; H04N 5/781

(52) U.S. Cl. 386/95; 386/111; 386/125

(57) ABSTRACT

The invention provides for a compressed-data processing arrangement (44) comprising buffer means (48) for receiving a stream of compressed data (46) and de-multiplexing means (48) for retrieving navigation information embedded within the compressed data, wherein the said buffer means comprises a common buffer (50) and further including pointer memory means (52) for storing a plurality of pointers arranged to identify sectors of data in the said common buffer (50) for the delivery of data to decoding means (54-60).

### FIELD OF INVENTION

The present invention relates to a compressed-data processing arrangement, comprising buffer means for receiving a stream of compressed data and de-multiplexing means for retrieving navigation information embedded within the compressed data, and also to a related method.

### BACKGROUND OF INVENTION

Such an arrangement and related method are known, for example, from U.S. Pat. No. 5,854,873, which discloses a standard technique for processing stored compressed data such as MPEG audio and/or video data. Such known techniques require the following five processing stages. First the compressed data is streamed from, for example, the storage media such as a DVD; secondly the order of the data to be processed is evaluated; thirdly the data is input into a track buffer arrangement in preparation for de-multiplexing; next the data is then de-multiplexed and output to the relevant decoders; and finally the data is then decoded at those decoders for onward delivery to an output channel.

It has been found that such known arrangements and related methods exhibit a disadvantageously limited efficiency and memory bandwidth utilization and also exhibit disadvantageous latency characteristics during data transfers.

### OBJECT OF INVENTION

The present invention seeks to provide for a compressed-data processing arrangement, and related method, offering an advantage over such known arrangements and methods.

### SUMMARY OF INVENTION

According to a first aspect of the present invention there is provided a compressed-data processing arrangement of the type defined above and characterised in that the buffer means comprises a common buffer and further including pointer memory means for storing a plurality of pointers arranged to identify sectors of data in the said common buffer for the delivery to decoding means.

With regard to the five stages exhibited by currently known processing systems, the subject of the present invention is derived in particular from an appreciation that, while the first and final stages can remain as standard for the vast majority of stored data processing systems, the present invention is advantageous in optimizing the second, third and fourth stages to provide for reordered and/or simultaneous operation so as to advantageously improve the efficiency and memory bandwidth utilization within the data processing arrangement whilst also serving to reduce the latency currently arising during data transfers. By employing the pointer memory, which serves to look to the common buffer and the actual content inside the sectors of the streamed data received from, for example, storage media such as a DVD, the invention advantageously allows for a direct path between the data and the common buffer and the subsequent decoders.

Thus, as will be appreciated, as compared with known arrangements, the present invention does not require individual buffers and, in a particular example, the invention employs a single unified buffer which is located within a main memory location within which the aforementioned pointer memory can also be located. Individual buffers are therefore not required for receiving the streamed data and this further serves to reduce the potential for latency between the data transfers.

According to another aspect of the present invention there is provided a method of processing compressed data, comprising the steps of receiving a stream of compressed data within buffering means and retrieving navigation information embedded within the compressed data by means of demultiplexing means, characterised by the steps of buffering the said compressed data in a common buffer and employing a plurality of stored pointers for identifying sectors of data in the said common buffer for the delivery to decoding means.

The feature of claim 2 is advantageous in enhancing the efficiency of operation of the present invention, whereas the feature of claim 3 is particularly advantageous in effectively sector-processing, and de-multiplexing, all the data found within the stored data stream substantially at the same time. This obviates the need for separate discarding of information at a later stage.

The feature of claim 4 is particularly advantageous in referencing the physical buffer employed within an embodiment of the present invention.

The feature of claim 5 is advantageous in effectively performing demultiplexing during instantaneous transfers of data. This has the further advantage of advantageously reducing the amount of memory required and so serves to speed-up the data processing.

The feature of claim 6 is particularly advantageous in seeking to minimize latencies that might otherwise arise during data transfers.

### BRIEF DESCRIPTION OF DRAWINGS

The invention is described further hereinafter, by way of example only, with reference to the accompanying drawings in which:

FIG. 1 is a schematic block diagram of a compressed-data processing arrangement known in the prior art;

FIG. 2 is a schematic block diagram of a compressed-data processing arrangement embodying the present invention;

FIG. 3 is a schematic block diagram illustrating pointer-referencing according to one embodiment of the present invention;

FIG. 4 is a schematic block diagram illustrating pointer referencing of the present invention in accordance with a further embodiment of the present invention; and

FIG. 5 is a block diagram of for example a DVD player embodying a compressed data processing and arrangement and method according to the present invention.

### DETAILED DESCRIPTION

Turning first to FIG. 1, there is illustrated a schematic block diagram of a compressed-data processing arrangement of the type currently known from the prior art.

The compressed-data processing arrangement 10 comprises a source 12 of channel data which outputs a signal to a 8/16 demodulation unit 14 which provides an output which is delivered to an error correction stage 16 which, in term, outputs a signal to a track buffer 18 and also to a system buffer 20 and DSI buffer 22. The DSI buffer 22 outputs a signal to a DSI decoder 24.

The track buffer 18 is arranged to deliver an output signal to a demultiplexer 26 which, in turn, provides separate signals to series connected buffer/decoder pairs comprising a video buffer/decoder pair 28, 30 and audio buffer/decoder pair 32, 34 a subpicture buffer/decoder pair 36, 38 and a PCI buffer/decoder pair 40, 42.

Such an arrangement exhibits disadvantages of the type discussed hereinbefore.

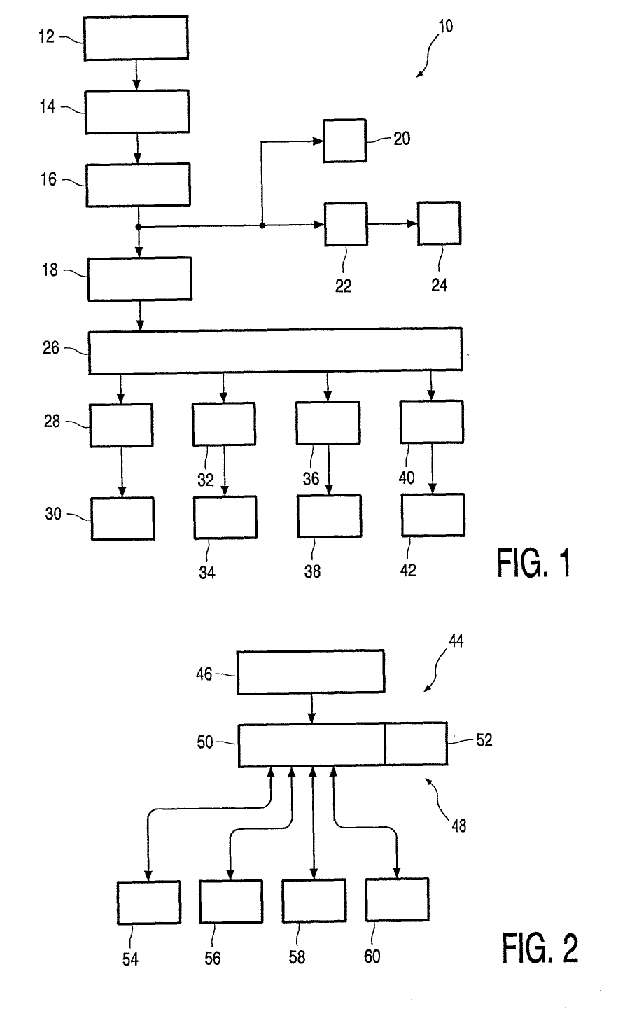

Turning now to FIG. 2, there is illustrated a compressed-data processing arrangement 44 according to an embodiment of the present invention and for receiving channel data from a data source 46. The arrangement comprises a main memory buffer 48 which itself comprises a unified buffer 50 and a pointer memory 52. The unified buffer is arranged to receive compressed data from a data channel 46 which carries compressed data retrieved from, for example, storage media such as a DVD.

Connected to the output side of the unified buffer is a plurality of decoders 54-60 arranged for decoding the compressed data and supplying output signals to subsequent output channels (not shown). Four decoders are illustrated in this example and comprise a video decoder 54, audio decoder 56, graphics decoder 58 and navigation information decoder 60. As illustrated by the arrows, the four decoders are each arranged to point directly at the relevant memory locations within the unified buffer 50 which are referenced by the pointers located in the pointer memory 52. These pointers are, as previously mentioned, located within the same memory block 48 as the unified buffer. In particular, it is considered that the use of a single buffer 50 serves to optimize the known requirements of identifying the order of the data to be processed, inserting the data into a track buffer and subsequently de-multiplexing the data for output to the various decoders and that are employed separately in the prior art.

The principal concept involved in the present invention relates to the use of pointers in the memory 52 to look at the unified buffer 50 and, in particular, the actual content inside the sectors that have been streamed from storage media such as a DVD. This provides a direct path between the data in the unified buffer through to the relevant decoders.

The principal distinguishing features of this embodiment of the invention as compared with the prior art are as follows.

First, individual buffers are not required and, as illustrated in FIG. 2, only a single main memory buffer 48 need be employed and which can also store pointers to the unified buffer 50 found within the main buffer memory 48. This advantageously overcomes the need for individual buffers for receiving transferred data and so can serve to reduce the amount of latency between data transfers.

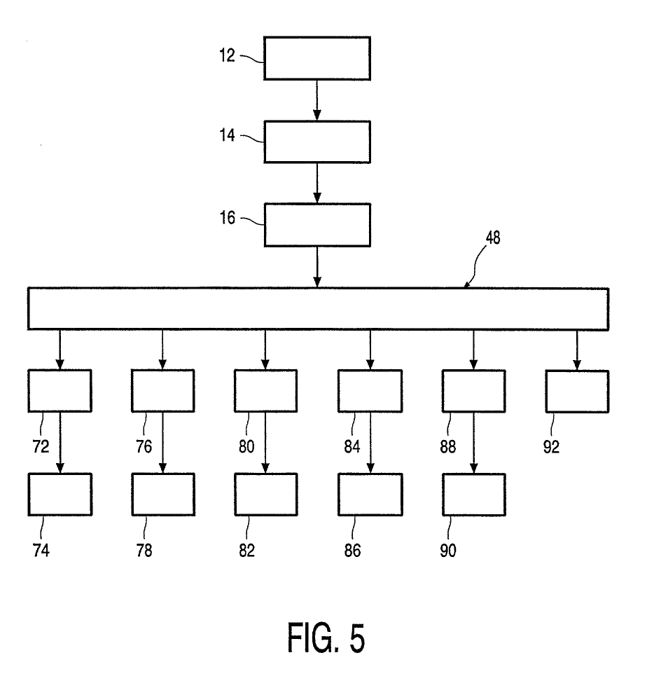

Secondly the necessary navigation information embedded in the data need only be de-multiplexed once. The navigation information is required to indicate the order of the group of sectors to be streamed. Rather than separately de-multiplexing this information out during a transfer, it can be handled by a single de-multiplexer as illustrated later with reference to FIG. 5. This effectively sector-processes and de-multiplexes all of the data within a stored stream at once and does not require the separate discarding of information at a later stage.

It should be appreciated that a method embodying the present invention can comprise a substantially software-based implementation, which can therefore provide greater flexibility and speed of operation for de-multiplexing and processing functions.

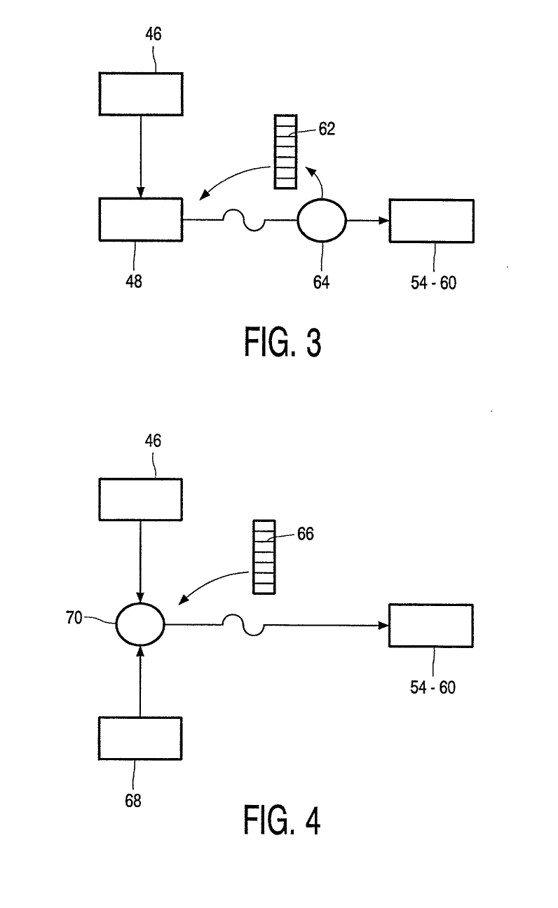

Various possibilities exist for achieving the pointer referencing required by embodiments of the present invention. FIG. 3 illustrates one example wherein the invention is arranged to allow for a larger amount of data to be cached into the unified buffer at any one time. A list of pointers 62 is then generated to determine where particular sectors of data are actually held in the unified buffer 48. This data is referenced by the list of pointers 62 which seek to identify the order of the groups of sectors.

Since sector and data-packet header IDs are found at a constant number of bytes into the sector, the pointers 62 can quickly and effectively look towards such locations to determine what type of data is present, while the data is actually being transmitted.

Such a cached-disk approach effectively performs the de-multiplexing at a de-multiplexor 64 during instantaneous transfers of the data. This advantageously serves to minimize the amount of memory required and to render the process much faster than current implementations.

In a second example illustrated with reference to FIG. 4, the method again employs a unified track buffer to cache a large amount of data. However rather than just determining where the sectors are held, a second list of pointers 66 is generated and seeks to identify exactly where the datapackets are and what type of data they contain. From this step a list of structures 68 detailing the order and position of the different types of data is generated which can then be used immediately by the subsequent decoder blocks via a de-multiplexer buffer 70.

This further example therefore serves to cache the de-multiplexing process before the data is transmitted. Although it may require more memory than the cached disk approach discussed above, since larger lists will be needed and must be updated each time the track buffer has been filled, this alternative approach will exhibit smaller latencies during transfers than the first approach as the data can be de-multiplexed and sent at a faster speed to the decoders.

Turning lastly to FIG. 5, there is illustrated, in block schematic form an arrangement according to an embodiment of the present invention found within, for example, a DVD player. Like reference numerals as used previously are employed where appropriate within FIG. 5 and in which the track buffer 48 is also arranged to provide for a single de-multiplexing stage which overcomes the need to separately de-multiplexes navigation information embedded within the channel data as a separate step.

The output from the combined track buffer/de-multiplexor 48 is delivered to series buffer/decoder pairs comprising a video buffer/decoder pair 72, 74, an audio buffer/decoder pair 76, 78, a subpicture buffer/decoder pair 80, 82, a PCI/decoder pair 84, 86, a DSI buffer/decoder pair 88, 90 and the system buffer 92.

The data then output from the decoders is delivered onto the display device of the DVD player in a manner which exhibits enhanced efficiency and memory bandwidth utilization, and also improved latency characteristics, as compared with arrangements currently known from the prior-art.

1. A compressed-data processing arrangement comprising buffer means for receiving a stream of compressed data and de-multiplexing means for retrieving navigation information embedded within the compressed data, characterised in that the said buffer means comprises a common buffer and further including pointer memory means for storing a plurality of pointers arranged to identify sectors of data in the said common buffer for the onward delivery of data to decoding means.

2. An arrangement as claimed in claim 1, wherein the common buffer and pointer memory are located in a common memory block.

3. An arrangement as claimed in claim 1 or 2, wherein the de-multiplexing means comprises a single de-multiplexer arranged to provide for common processing and de-multiplexing of all data within the data stream substantially at the same time.

4. An arrangement as claimed in claim 1, 2 or 3, wherein the pointers are arranged to identify buffer pointer off-set collections within the sectors of data stored within the common buffer.

5. An arrangement as claimed in any one of claims 1-4, wherein the pointers are arranged to determine the location of data sectors in the common buffer, and such that the data is then referenced by a list of pointers seeking to identify the order of the groups of sectors.

6. An arrangement as claimed in any one of claims 1-4, when the pointer memory is arranged to include a second list of pointers serving to identify the location of packets of data and also to identify the data contained therein.

7. A DVD player including a compressed-data processing arrangement as claimed in any one of claims 1-6.

8. A set-top-box arrangement including a compressed-data processing arrangement as claimed in any one of claims 1-6.

9. A method of processing compressed data, comprising the steps of receiving a stream of compressed data within buffering means and retrieving navigation information embedded within the compressed data by means of de-multiplexing means, characterised by the steps of buffering the said compressed data in a common buffer and employing a plurality of stored pointers for identifying sectors of data in the said common buffer for delivery to decoding means.

10. A method as claimed in claim 9, wherein the said navigation information is retrieved by way of a single de-multiplexer arranged to provide for common processing and de-multiplexing of all data within the data stream substantially at the same time.

11. A method as claimed in claim 9 or 10, and including the step of employing the pointers to identify buffer pointer off-set collections within the sectors of data stored within the common buffer.

12. A method as claimed in claim 9, 10 or 11, and including the steps of arranging the said pointers to determine the location of data sectors in the common buffer, and then referencing the said data by the list of pointers seeking to identify the order of the groups of sectors.

13. A method as claimed in claim 9, 10 or 11, and including arranging the pointer memory to include a second list of pointers serving to identify the location of packets of data and also to identify the data contained therein.
